(19) United States
(12) Patent Application Publication
(10) Pub. No.: US 2026/0194898 A1
(43) Pub. Date: Jul. 9, 2026

(54) FLIGHT REGIME PREDICTION BASED ON HISTORICAL FLIGHT PARAMETERS

(71) Applicant: Textron Innovations Inc., Providence, RI (US)

(72) Inventors: Juan Li, Keller, TX (US); Brian Tucker, Fort Worth, TX (US)

(21) Appl. No.: 19/010,635

(22) Filed: Jan. 6, 2025

(51) Int. Cl. G05B 23/02; G07C 5/00

(52) U.S. Cl. CPC G05B 23/0283; G07C 5/006

(57) ABSTRACT

An embodiment system includes one or more processors and non-transitory computer readable memory including computer program code to cause the system to provide a long short-term memory (LSTM) model trained to associate one or more flight parameters with a flight regime that is one or more actions taken during operation of an aircraft, acquire first flight parameter data associated with data collected at a sample time and during operation of an aircraft, provide the first flight parameter data to the LSTM model causing the LSTM model to predict a predicted flight regime according to the training of the LSTM and first flight parameter data, determine at least a fatigue statistic for one or more elements of the aircraft according to the predicted flight regime, and provide a notification regarding the fatigue statistic exceeding a threshold.

### TECHNICAL FIELD

The present invention relates generally to a system and method for managing data for vehicle usage and fatigue monitoring, and, in particular embodiments, to a system and method for using a neural network to determine flight regimes of aircraft based on flight data.

### BACKGROUND

An aircraft, such as a rotorcraft, may include one or more rotor systems including one or more main rotor systems, transmissions, and engines powering the main rotor systems. A main rotor system generates aerodynamic lift to support the weight of the rotorcraft in flight and thrust to move the rotorcraft in forward flight, and therefore, experiences significant use and wear during flight. Similarly, a tilt rotor aircraft has multiple engines, transmissions and rotor systems, in addition to engine or nacelle tilting mechanisms. These power and rotor angle control systems are the primary mechanical systems within the tiltrotor. The systems for engines, transmissions, drive system, rotors, nacelle or engine tilting mechanisms, and the like, are critical to the safe operation of the aircraft in flight. The elements of system such as mechanical systems, electrical systems, hydraulic systems, and the like, are each subject to unique wear factors and monitoring, inspection or maintenance requirements.

Many rotorcraft, tiltrotor vehicles, and other vehicles are fitted with condition and health monitoring equipment to determine when components or operating elements may wear out. For example, an aircraft may use flight data, such as data acquired via flight sensors, a monitoring system that gathers vibration and/or speed data, or other data acquisition systems to determine the condition of vehicle components.

The presented systems and methods relate generally to a system and method for providing an artificial intelligence (AI) model or agent using a neural network (NN) and in particular, to an AI model trained to recognize or predict flight regimes based on sensed flight parameters.

### SUMMARY

An embodiment system includes one or more processors, and at least one non-transitory computer readable memory connected to the one or more processors and including computer program code, where the at least one non-transitory computer readable memory and the computer program code are configured, with the one or more processors, to cause the system to at least provide a long short-term memory (LSTM) model trained to associate one or more flight parameters with a flight regime, where the flight regime is one or more actions taken during operation of an aircraft, acquire first flight parameter data associated with data collected at a sample time and during operation of an aircraft, provide the first flight parameter data to the LSTM model, the providing the first flight parameter data causing the LSTM model to predict a predicted flight regime according to the training of the LSTM and first flight parameter data, determine at least a fatigue statistic for one or more elements of the aircraft according to the predicted flight regime, and provide a notification regarding the fatigue statistic exceeding a threshold.

An embodiment system includes one or more processors, and at least one non-transitory computer readable memory connected to the one or more processors and including computer program code, where the at least one non-transitory computer readable memory and the computer program code are configured, with the one or more processors, to cause the system to at least provide an artificial intelligence neural network with a long short-term memory (LSTM) model, where the at least one non-transitory computer readable memory and the computer program code are configured, with the one or more processors, to cause the LSTM model to at least maintain one or more associations between one or more flight parameters and one or more flight regimes, where each flight regime of the one or more flight regimes is one or more actions taken during operation of an aircraft, maintain first stored flight parameter data having collection times within a sample window, receive first received flight parameter data associated with data collected at a sample time and during operation of an aircraft, adjust the sample window to include the first received flight parameter data and to generate second stored flight parameter data that includes the first received flight parameter data, and predict a predicted flight regime according to the one or more associations and the stored second flight parameter data, and provide data indicating the predicted flight regime to a system that generates a notification based on the predicted flight regime.

An embodiment method includes providing a long short-term memory (LSTM) model trained to associate one or more flight parameters with a flight regime, where the flight regime is one or more actions taken during operation of an aircraft, acquiring first flight parameter data associated with data collected at a sample time and during operation of an aircraft, providing the first flight parameter data to the LSTM model, the providing the first flight parameter data causing the LSTM model to predict a predicted flight regime according to the training of the LSTM and first flight parameter data, determining at least a fatigue statistic for one or more elements of the aircraft according to the predicted flight regime, and providing a notification regarding the fatigue statistic exceeding a threshold.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a rotorcraft according to some embodiments;

FIG. 2 illustrates a fly-by-wire flight control system for an aircraft according to some embodiments;

FIG. 3 is a block diagram illustrating a flight regime prediction system according to some embodiments;

FIG. 4A is a logical diagram illustrating an LSTM neuron according to some embodiments;

FIG. 4B is a logical diagram illustrating a flight regime prediction system with LSTM layers according to some embodiments;

FIG. 5 is a flow diagram illustrating a system for training of an LSTM system according to some embodiments;

FIG. 6A is a logical diagram illustrating a system for selection of a training data feature set for training an LSTM model according to some embodiments;

FIG. 6B is a logical diagram illustrating a method for using of training data to train an LSTM model according to some embodiments;

FIG. 6C is a logical diagram illustrating a method for using an LSTM model to predict flight regimes according to some embodiments;

FIG. 7 is a table illustrating LSTM regime prediction validation according to some embodiments; and

FIG. 8 is a flow diagram illustrating a method for using an LSTM model for regime prediction according to some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The increasing use of rotorcraft, in particular, for commercial and industrial applications, has led to the development of larger more complex rotorcraft. However, as rotorcraft become larger and more complex, the differences between flying rotorcraft and fixed wing aircraft has become more pronounced. Since rotorcraft and tilt-sing aircraft use one or more rotors to simultaneously provide lift, control attitude, control altitude, and provide lateral or positional movement, different flight parameters and controls are tightly coupled to each other, as the aerodynamic characteristics of the main rotors affect each control and movement axis. For example, the flight characteristics of a tilt-wing aircraft at cruising speed or high speed may be significantly different than the flight characteristics at hover or at relatively low speeds. Additionally, different flight control inputs for different axes on the rotors, such as nacelle angles, affect other flight controls or flight characteristics of the rotorcraft.

Recently, fly-by-wire (FBW) systems have been introduced in tilt-wing aircraft and rotorcraft to assist pilots in stably flying the rotorcraft and to reduce workload on the pilots. The FBW system may provide different control characteristics or responses for control input in the different flight regimes, and may provide stability assistance or enhancement by decoupling physical flight characteristics so that a pilot is relieved from needing to compensate for some flight commands issued to the aircraft. FBW systems may be implemented in one or more flight control computers (FCCs) disposed between the pilot controls and flight control systems, providing corrections to flight controls that assist in operating the rotorcraft more efficiently or that put the rotorcraft into a stable flight mode while still allowing the pilot to override the FBW control inputs. The FBW systems in an aircraft may, for example, automatically adjust power output by the engine to match a collective control input or nacelle angle, provide automation of one or more flight control procedures provide for default or suggested control positioning, or the like.

Embodiments of the system presented herein are directed to taking advantage of the FBW systems that track flight conditions or other sensed parameters, and using sensor data indicating flight parameters for an aircraft to determine a flight regime for the aircraft. Flight regimes may include different actions taken during operation of an aircraft that tend to accumulate usage or wear on an aircraft. The flight regime may be used to determine total usage, fatigue, or wear on systems, subsystems, parts, or other elements of an aircraft. For example, high power usage during multiple landings and takeoffs may result in increased wear on engines and transmissions, while turn at high pressure, or maximum Q (mechanical pressure), impart maximum mechanical stress on the airframe and lifting features. For example, for a rotorcraft, a max Q turn may impart large mechanical stress forces on rotor blades and rotor heads or pylons, while for a tilt-wing craft, a max Q turn may impart large mechanical stresses on wings and pylons or nacelles, tilting mechanisms, rotors and the like. Additionally, accurate determination of flight regimes avoids a presumption of fatigue based on a flight plan, and based on nonflexible thresholds for identifying the flight regimes. This results in more accurate calculation of fatigue on parts, and potentially avoids early or unneeded replacement of parts.

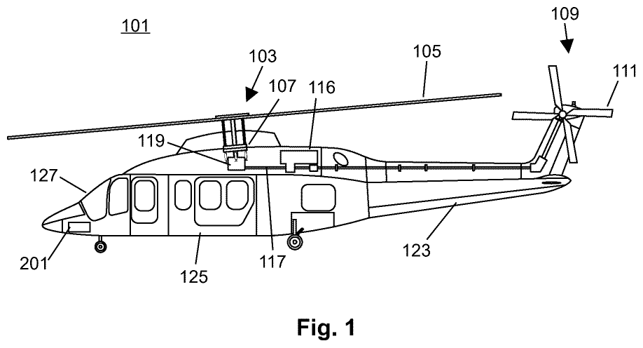

FIG. 1 illustrates a rotorcraft 101 according to some embodiments. The rotorcraft 101 has a main rotor system 103, which includes a plurality of main rotor blades 105. The pitch of each main rotor blade 105 may be controlled by a swashplate 107 in order to selectively control the attitude, altitude and movement of the rotorcraft 101. The swashplate 107 may be used to collectively and/or cyclically change the pitch of the main rotor blades 105. The rotorcraft 101 also has an anti-torque system, which may include a tail rotor 109, no-tail-rotor (NOTAR), or dual main rotor system. In rotorcraft with a tail rotor 109, the pitch of each tail rotor blade 111 is collectively changed in order to vary thrust of the anti-torque system, providing directional control of the rotorcraft 101. The pitch of the tail rotor blades 111 is changed by one or more tail rotor actuators. In some embodiments, the FBW system sends electrical signals to the tail rotor actuators or main rotor actuators to control flight of the rotorcraft.

Power is supplied to the main rotor system 103 and the anti-torque system by engines 116. There may be one or more engines 116, which may be controlled according to signals from the FBW system. The output of the engines 116 is provided to a driveshaft 117, which is mechanically and operatively coupled to the rotor system 103 and the anti-torque system through a main rotor transmission 119 and a tail rotor transmission, respectively.

The rotorcraft 101 further includes a fuselage 125 and tail section 123. The tail section 123 may have other flight control devices such as horizontal or vertical stabilizers, rudder, elevators, or other control or stabilizing surfaces that are used to control or stabilize flight of the rotorcraft 101. The fuselage 125 includes a cockpit 127, which includes displays, controls, and instruments. It should be appreciated that even though rotorcraft 101 is depicted as having certain illustrated features, the rotorcraft 101 may have a variety of implementation-specific configurations. For instance, in some embodiments, cockpit 127 is configured to accommodate a pilot or a pilot and co-pilot, as illustrated. It is also contemplated, however, that rotorcraft 101 may be operated remotely, in which case cockpit 127 could be configured as a fully functioning cockpit to accommodate a pilot (and possibly a co-pilot as well) to provide for greater flexibility of use, or could be configured with a cockpit having limited functionality (e.g., a cockpit with accommodations for only one person who would function as the pilot operating perhaps with a remote co-pilot or who would function as a co-pilot or back-up pilot with the primary piloting functions being performed remotely. In yet other contemplated embodiments, rotorcraft 101 could be configured as an unmanned vehicle, in which case cockpit 127 could be eliminated entirely in order to save space and cost.

In an analogous tilt-wing system, the aircraft may have pylons on wings, with the pylons having rotors that tilt to provide forward thrust and/or vertical lift. However, the tilt-rotor aircraft may have an analogous cockpit 127, fuselage, and tail section 123. While the propulsion and lift systems of a tilt-rotor aircraft may be different from that of a pure rotorcraft 101, the control systems, and flight regime management systems may be analogous.

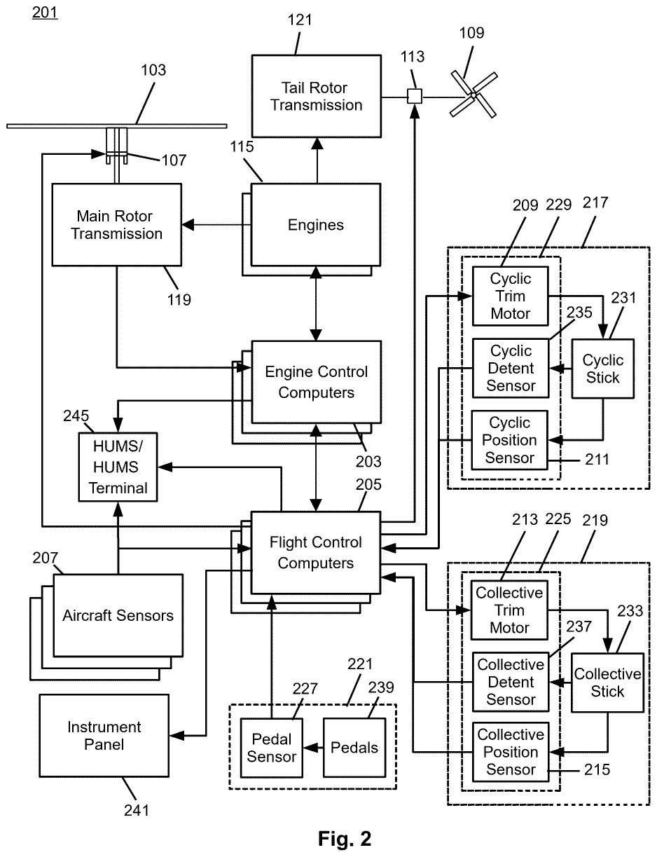

FIG. 2 illustrates a fly-by-wire flight control system 201 for a rotorcraft according to some embodiments. A pilot may manipulate one or more pilot flight controls in order to control flight of the rotorcraft. The pilot flight controls may include manual controls such as a cyclic stick 231 in a cyclic control assembly 217, a collective stick 233 in a collective control assembly 219, and pedals 239 in a pedal control assembly 221. Inputs provided by the pilot to the pilot flight controls may be transmitted mechanically and/or electronically (e.g., via the FBW flight control system) to flight control devices by the flight control system 201. Flight control devices may represent devices operable to change the flight characteristics of the rotorcraft. Flight control devices on the rotorcraft may include mechanical and/or electrical systems operable to change the positions or angle of attack of the main rotor blades 105 and the tail rotor blades 111 or to change the power output of the engines 116, as examples. Flight control devices include systems such as the swashplate 107, tail rotor actuator 113, and systems operable to control the engines 116. The flight control system 201 may adjust the flight control devices independently of the flight crew in order to stabilize the rotorcraft, reduce workload of the flight crew, and the like. The flight control system 201 includes engine control computers (ECCUs) 203, flight control computers (FCCs) 205, and aircraft sensors 207, which collectively adjust the flight control devices and monitor the rotorcraft during operation.

The flight control system 201 has one or more FCCs 205. In some embodiments, multiple FCCs 205 are provided for redundancy. One or more modules within the FCCs 205 may be partially or wholly embodied as software and/or hardware for performing any functionality described herein. In embodiments where the flight control system 201 is an FBW flight control system, the FCCs 205 may analyze pilot inputs and dispatch corresponding commands to the ECCUs 203, the tail rotor actuator 113, and/or actuators for the swashplate 107. Further, the FCCs 205 are configured and receive input commands from the pilot controls through sensors associated with each of the pilot flight controls. The input commands are received by measuring the positions of the pilot controls. The FCCs 205 also control tactile cues to the pilot controls or display information in instruments on, for example, an instrument panel 241.

The ECCUs 203 control the engines 116. For example, the ECCUs 203 may vary the output power of the engines 116 to control the rotational speed of the main rotor blades or the tail rotor blades. The ECCUs 203 may control the output power of the engines 116 according to commands from the FCCs 205, or may do so based on feedback such as measured revolutions per minute (RPM) of the main rotor blades.

The cyclic control assembly 217 is connected to a cyclic trim assembly 229 having one or more cyclic position sensors 211, one or more cyclic detent sensors 235, and one or more cyclic actuators or cyclic trim motors 209. The cyclic position sensors 211 measure the position of the cyclic stick 231. In some embodiments, the cyclic stick 231 is a single control stick that moves along two axes and permits a pilot to control pitch, which is the vertical angle of the nose of the rotorcraft and roll, which is the side-to-side angle of the rotorcraft. In some embodiments, the cyclic control assembly 217 has separate cyclic position sensors 211 that measuring roll and pitch separately. The cyclic position sensors 211 for detecting roll and pitch generate roll and pitch signals, respectively, (sometimes referred to as cyclic longitude and cyclic latitude signals, respectively) which are sent to the FCCs 205, which controls the swashplate 107, engines 116, tail rotor 109 or related flight control devices.

The cyclic trim motors 209 are connected to the FCCs 205, and receive signals from the FCCs 205 to move the cyclic stick 231. In some embodiments, the FCCs 205 determine a suggested cyclic stick position for the cyclic stick 231 according to one or more of the collective stick position, the pedal position, the speed, altitude and attitude of the rotorcraft, the engine RPM, engine temperature, main rotor RPM, engine torque or other rotorcraft system conditions or flight conditions, or according to a predetermined function selected by the pilot. The suggested cyclic stick position is a position determined by the FCCs 205 to give a desired cyclic action. In some embodiments, the FCCs 205 send a suggested cyclic stick position signal indicating the suggested cyclic stick position to the cyclic trim motors 209. While the FCCs 205 may command the cyclic trim motors 209 to move the cyclic stick 231 to a particular position (which would in turn drive actuators associated with swashplate 107 accordingly), the cyclic position sensors 211 detect the actual position of the cyclic stick 231 that is set by the cyclic trim motors 206 or input by the pilot, allowing the pilot to override the suggested cyclic stick position. The cyclic trim motor 209 is connected to the cyclic stick 231 so that the pilot may move the cyclic stick 231 while the trim motor is driving the cyclic stick 231 to override the suggested cyclic stick position. Thus, in some embodiments, the FCCs 205 receive a signal from the cyclic position sensors 211 indicating the actual cyclic stick position, and do not rely on the suggested cyclic stick position to command the swashplate 107.

Similar to the cyclic control assembly 217, the collective control assembly 219 is connected to a collective trim assembly 225 having one or more collective position sensors 215, one or more collective detent sensors 237, and one or more collective actuators or collective trim motors 213. The collective position sensors 215 measure the position of a collective stick 233 in the collective control assembly 219. In some embodiments, the collective stick 233 is a single control stick that moves along a single axis or with a lever type action. A collective position sensor 215 detects the position of the collective stick 233 and sends a collective position signal to the FCCs 205, which controls engines 116, swashplate actuators, or related flight control devices according to the collective position signal to control the vertical movement of the rotorcraft. In some embodiments, the FCCs 205 may send a power command signal to the ECCUs 203 and a collective command signal to the main rotor or swashplate actuators so that the angle of attack of the main blades is raised or lowered collectively, and the engine power is set to provide the needed power to keep the main rotor RPM substantially constant.

The collective trim motor 213 is connected to the FCCs 205, and receives signals from the FCCs 205 to move the collective stick 233. Similar to the determination of the suggested cyclic stick position, in some embodiments, the FCCs 205 determine a suggested collective stick position for the collective stick 233 according to one or more of the cyclic stick position, the pedal position, the speed, altitude and attitude of the rotorcraft, the engine RPM, engine temperature, main rotor RPM, engine torque or other rotorcraft system conditions or flight conditions, or according to a predetermined function selected by the pilot. The FCCs 205 generate the suggested collective stick position and send a corresponding suggested collective stick signal to the collective trim motors 213 to move the collective stick 233 to a particular position. The collective position sensors 215 detect the actual position of the collective stick 233 that is set by the collective trim motor 213 or input by the pilot, allowing the pilot to override the suggested collective stick position.

The pedal control assembly 221 has one or more pedal sensors 227 that measure the position of pedals or other input elements in the pedal control assembly 221. In some embodiments, the pedal control assembly 221 is free of a trim motor or actuator, and may have a mechanical return element that centers the pedals when the pilot releases the pedals. In other embodiments, the pedal control assembly 221 has one or more trim motors that drive the pedal to a suggested pedal position according to a signal from the FCCs 205. The pedal sensor 227 detects the position of the pedals 239 and sends a pedal position signal to the FCCs 205, which controls the tail rotor 109 to cause the rotorcraft to yaw or rotate around a vertical axis.

The aircraft sensors 207 may be in communication with the FCCs 205, and a health and usage monitoring system (HUMS) 245. The aircraft sensors 207 may include sensors for monitoring operation of the rotorcraft, providing pilot data, providing condition data, or the like, and may include measuring a variety of rotorcraft systems, operating conditions, flight parameters, environmental conditions, and the like. For example, the aircraft sensors 207 may include sensors for gathering flight data, and may include sensors for measuring airspeed, altitude, attitude, position, orientation, temperature, vertical speed, and the like. The aircraft sensors 207 may include sensors relying upon data or signals originating external to the rotorcraft, such as a global positioning system (GPS) sensor, a very high frequency (VHF) omnidirectional range sensor, Instrument Landing System (ILS), and the like. Additionally, one or more aircraft sensors 207 may include sensors for reading operational data such as vibration, device rotational speed, electrical operating characteristics, fluid flows, stress, operating temperatures, or the like.

In an analogous tilt-rotor aircraft, the control systems, such as the cyclic assembly 217 and collective assembly 219 may be configured to control tilt of engine pylons or rotors, and to control flight control surfaces, engines, rotor pitch, and the like. However, the FCCs 205, sensors 207, and the like, may operate in a similar fashion.

Embodiments of the presented principles are directed to a system and method for using a neural network to identify flight regimes from sensor data or other collected data. In some embodiments, a flight regime prediction system uses LSTM models to identify the flight regimes, and may perform the flight regime prediction based on training for flight regime identification performed on the LSTM. Identification of the flight regimes may be performed in real-time or near real-time, and may be used to trigger notifications or warnings regarding overuse or excessive wear on elements of the aircraft, or may be used to perform maintenance management or mission or flight planning. For example, flight regime prediction may be used to estimate the wear or use of discrete systems, subsystems, or parts for an aircraft, and maintenance may be planned based on the observed activity or identified flight regimes that an aircraft experiences. Thus, identified flight regimes may be associated with wear, use or fatigue amounts for elements of the aircraft. The cumulative wear for each element of the aircraft, such as a system, subsystem, part or the like, may be tracked for vehicle management. For example, an alert may be raised to a pilot before, or during a flight if the fatigue or wear on a particular element exceeds a threshold. In another example, if the fatigue, use, or the like for a particular aircraft element is determined, from for example, the predicted flight regime determinations, to exceed a maintenance threshold, a maintenance system may flag the aircraft for maintenance, or may flag the aircraft element for maintenance, inspection, or another maintenance process during a scheduled maintenance.

In some embodiments, a model for flight regime prediction is trained using previously received data. The model may be a model generated using machine learning, and may include an LSTM model. In some embodiments, one or more other AI models or elements may be used with the LSTM model to provide data identification, pattern recognition, data management, or the like.

The use of LSTM AI models to identify the flight regime provides faster, more accurate flight regime identification compared to an analytical process, and avoid the need to set rules for matching flight parameters to flight regimes. Previous analytical method used a decision tree implementing Boolean logic with monitored parameters, for example, airspeed, control stick reversals, on-ground states, pitch or roll rate, vertical velocity, rate of climb (ROC) airspeed, or the like, to determine a particular flight regime. However, the analytical system tended to use fixed thresholds for the monitored parameters, resulting in rigid rules for a flight pattern falling into a particular flight regime. However, the current practice is time consuming due to the complex logic defined in the decision tree method, and not very robust when there is variance from pilot operation, environment or collected signal noise. In contrast, the LSTM system provides for greater flexibility and accuracy in identifying the flight regimes, and exhibits increased speed in flight regime identification.

The LSTM AI system predicts flight regime type based on historical flight parameter data using artificial intelligence technologies. Flight parameters are time series. All the maneuvers are related in sequence. The LSTM AI system captures the pattern behind the data sequence and predicts the flight regime type of next data point based on past flight parameters in a selected duration. An LSTM AI system in particular may learn which information might be needed later and when the information is no longer needed, which increases the robustness of flight regime recognition model. Additionally, once the model has been trained based on flight test data, the process to predict regime types only takes few milliseconds, which increases the efficiency, and also provides the onboard real time prediction capability. A developed usage spectrum with accurate regime recognition is helpful for generating a good fatigue life estimation and maintenance plan of structural components. With a preliminary evaluation, the model can provide greater than 93% prediction accuracy.

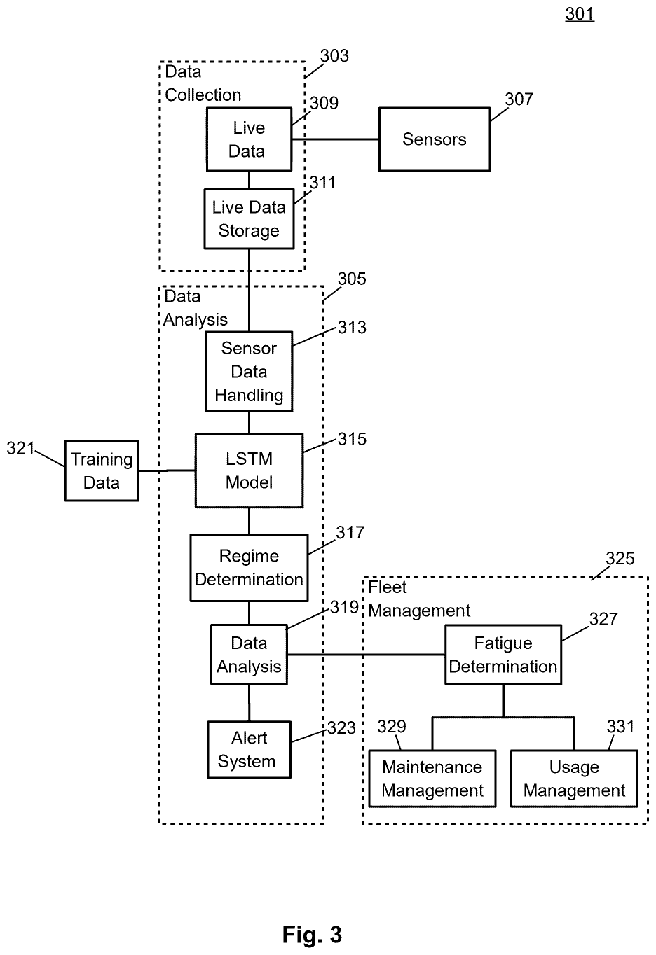

FIG. 3 is a block diagram illustrating a flight regime prediction system 301 according to some embodiments. The flight regime prediction system 301 may gather, process, and analyze flight parameter data to determine or predict a flight regime according to some embodiments. The system 301 may include a data collection element 303 that collects and processes live data 309 for storage in a live data storage element 311. The data collection element 303 may be connected to one or more sensors 307. The sensors 307 may be sensors that gather flight data associated with the operation or status of an aircraft such as operational parameters, flight parameters, or other flight data. For example, the sensors 307 may collect data such as airspeed, altitude, attitude, position, orientation, temperature, vertical speed, control stick positioning, throttle positioning, tilt rotor or wing pylon positioning, and the like. The sensors 307, as discussed above, and may take sensor readings and generate one or more sensor signals such as electrical signals, data elements, or the like, that indicate flight data or one or more operational parameters.

In some embodiments, the system 301 may further have a data analysis element 305 that determines a flight regime according to the live data 309. In some embodiments, an LSTM model 315 of the data analysis element 305 may use selected flight parameters for flight regime recognition. In some embodiments, the LSTM model 315 that determines a flight regime for a tilt-rotor aircraft may determine the flight regime using flight parameters such as a calibrated airspeed, load factor, roll attitude, true heading, pitch rate, vertical velocity, rotor rpm, nacelle angle, thrust control lever position, radar altitude, lightweight inertial navigation system (LWINS) ground speed, or the like, to determine a flight regime for the tilt-rotor aircraft. In embodiment where the LSTM model 315 is determining a flight regime for a rotorcraft, the LSTM model 315 may determine a flight regime using similar flight parameters relevant to the rotorcraft. For example, the flight parameters for a rotorcraft may include calibrated airspeed, load factor, roll attitude, true heading, pitch rate, vertical velocity, rotor rpm, main rotor blade collective or cyclic angle, collective stick position, radar altitude, LWINS ground speed, or the like.

The data collection element 303 may be a computer or other device that receives the sensor signals and stores data associated with the sensor signals locally for later analysis. In some embodiments, one or more of the FCCs or ECCUs are data collection elements 303, and in other embodiments, the data collection element 303 is a standalone device. The data collection element 303 has a data acquisition element such as a processor, data collection circuit or device, or the like. In some embodiments, the data collection element 303 is a dedicated terminal, centralized device or standalone device that collects raw sensor data from the sensors 307 and that determines flight parameters from the raw sensor data, from processed data, or from a sensor signal, or that collects flight parameter data from the sensors 307.

In some embodiments, the FCCs may provide the flight parameter data or other data used to generate flight parameters or flight parameter data. The FCCs may, in some embodiments, use data that is generated or otherwise acquired by the FCCs to determine the flight parameters. For example, the FCCs may receive commands from control elements in a cockpit indicating a desired vertical velocity, rotor rpm, nacelle angle, thrust control lever position, or the like. The FCCS may provide control signals that adjust the relevant aircraft elements, and may receive feedback or signals regarding positioning or state of aircraft or aircraft elements, and may use the feedback to determine the relevant flight parameters that may be saved by the FCCs or by a dedicated or separate data collection element 303.

In other embodiments, the data collection element 303 is a device that receives calculated or analyzed data such as data sets, alerts, flight performance data, or the like, from sensors 307 that determine the flight parameters or flight parameter data. In yet another embodiment, the data collection element 303 may be, or include, a network of smart sensors 307 that act autonomously to collect data, and may determine flight parameters or flight parameter data and perform some analysis of the sensor data or flight parameters. In such an embodiment, the smart sensors 307 may store the collected and calculated data or analyzed data for delivery directly to the data analysis element 305. In some embodiments, the data collection element 303 also includes a communications circuit that receives the sensor signal from the sensors 307 and saves sensor data based on the sensor signal in live data storage element 311.

In some embodiments, the data analysis element 305 receives raw sensor data or flight parameter data from the data collection element 303 or from the sensors 307 associated with the data collection element 303, and performs analysis to determine condition indicators from the condition data or raw sensor data. In other embodiments, the data collection element 303 performs the analysis and sends processed data, such as a such as flight parameter data, data sample, or the like, to the data analysis element 305.

The data collection element 303 may store data such as the sensor data, a sample of sensor data, flight parameter data, and other sensor data or relevant identifying information in the live data storage element 311. In some embodiments, the flight parameter may be tagged with a date, time, and operational parameter information when stored in the live data storage element 311 for transmission to the data analysis element 305.

In some embodiments, the data analysis element 305 has a sensor data handling element 313 that may, in some embodiments, prepare or process sensor data or other data from one or more data collection elements. The sensor data handling element 313 may, for example, generate flight parameter data from one or more sensor data points such as data collected by the FCCs, or the like.

The data analysis element 305 aggregates data from one or more data collection elements 303. In some embodiments, the data analysis element 305 collects data in one or more flight parameter data sets for aggregation and analysis, and sends the flight parameter data through the sensor data handling element 313 to the LSTM model 315 for processing. The LSTM model may be trained on training data 321s that indicates a relationship, correlation, or other association between flight parameters and flight regimes. Thus, the LSTM model 315 may be trained to identify or predict a flight regime based on flight parameters or flight parameter data sent from the data collection element 303.

The LSTM model 315 may include a regime determination element 317, or may include the regime determination element 317 within the LSTM model 315. The regime determination element 317 may determine, based on the training provided to the LSTM model 315, a flight regime for a time period for which flight parameters are provided. For example, the data collection element 303 may collect data over a discrete window, that is, for example, between about 0.5 and 5 seconds, and in some embodiments, is between about 1.5 and 2.5 seconds, or in some embodiments, is about 2 seconds. A flight parameter data set may include flight parameter data for a window. A flight parameter data set may include multiple data points from a sequence of times within a window. For example, a flight parameter data set may include samples or readings of sensor data or flight parameter data from each monitored flight parameter at a rate of 20 samples per sample window. The flight parameter data may be processed by, for example, the sensor data handling element 313 to determine a flight action or other intermediate flight action indication. The processed flight parameter data set may then be provided to the LSTM model 315, which is trained by training data to determine, from the flight parameter data set, whether an identified flight regime has occurred. The regime determination element 317 may then determine the flight regime from the flight parameter data set. In embodiments, where the LSTM model 315 implements the regime determination element 317, the LSTM model 315 may take in the flight parameter data set, and generate the type of the flight regime occurring in the sample window.

In some embodiments, the data analysis element 305 may be, for example, a server that is remote from the data collection element 303, or may be local to, or the same device as the data collection element 303. In some embodiments, the data collection element 303 and data analysis element 305 are both disposed in a vehicle such as an aircraft, and may both be implemented in one or more FCCs. In other embodiments, the data collection element 303 may be implemented in a device that is distinct from the device implementing the data analysis element 305. For example, the data collection element 303 may be implemented in a dedicated monitoring computer or device using, for example, a purpose built processor, microcontroller, or the like, or may be implemented in an ECCU or other control computer, while the data analysis element 305 is implemented in, for example, an FCC. In other embodiments, the data analysis element 305 may be a diagnostic computer, remote server, or the like, that is separate from the vehicle on which the data collection element 303 is disposed. The data collection element 303 may transfer data to the data analysis element 305 by responding to a query from a maintenance computer, automatically transferring data to a remote data analysis element 305 through a wireless connection, a manual transfer or download by a user using, for example, a non-transitory computer readable medium such as a universal serial bus (USB) stick or secure digital (SD) card, or the like.

In some embodiments, the data analysis element 305 has a data analysis element 319 and an alert system 323. In some embodiments, the data analysis element 319 may be a system separate from the system hosting the LSTM model 315, or in other embodiments, may be resident on a same host, sever, computer or the like, that hosts the LSTM model 315. In some embodiments, the data analysis element 319 may determine whether the flight regime, alone, or in combination with preceding or previous flight regimes, exceeds a threshold for use, fatigue, or the like, and the alert system 323 may raise an alert to a pilot or crew member if needed. For example, the regime determination element 317 may determine that received flight parameters indicate that a flight regime an aircraft has most recently engaged in is a constant airspeed, level right turn at max Q. The data analysis element 319 may determine that the most recent max Q turn flight regime has caused an aircraft element, such as a wing, to exceed a maximum fatigue, and needs to be inspected or repaired. The data analysis element 319 may then cause the alert system 323 to issue an alert to avoid further high Q turns, or that maintenance or inspection is needed.

The alert system 323 may, in some embodiments, provide an alert indicating that vehicle conditions has exceeded a particular threshold such as a static indicator threshold, static alert threshold or an adaptable alert threshold, a combination of the same, or the like. The alert system 323 may provide the alert to a vehicle operator, a maintenance technician, a fleet operator, a vehicle, owner, or to an automated system. The alert system 323 may be disposed in the vehicle, and may include a cockpit indicator that is an audible indicator such as a buzzer or voice prompt provided through a flight director system, a graphic warning such as a note or other warning on a graphic screen, instrument screen, flight director screen, or the like, or may be provided as a dedicated visual indicator such as a dedicated warning light, lamp, or the like. In other embodiments, the alert system 323 may be remote from the vehicle, and may provide an automated alert by generating a report with a list of conditions of concern, automatically messaging a technician or owner, providing an indicator on a monitoring system, or the like. For example, a data analysis element 305 may be a monitoring server at a fleet operator, and the vehicle may automatically transmit condition indicators to the data server by way of a wireless link, or through a maintenance computer connected to the vehicle by a technician.

In some embodiments, a fleet management system 325 may collect data from one or more aircraft, or from one or more data analysis elements 305. The fleet management system 325 may be a standalone system that is in communication, either persistently, or intermittently, with the one or more data analysis elements 305. For example, a fleet management system 325 may connect to a data analysis element 305 aboard an aircraft wirelessly, for example, during flight, via a data connection, or when the aircraft enters a service area of the fleet management system 325, for example, at a landing strip, airport, service area, base, or the like. In other embodiments, data from the data analysis element 305 may be communicated to the fleet management system 325 by, for example, a technician connecting a data terminal to the aircraft to retrieve flight parameter data or flight regime data from the data analysis element 305, which is then provided by the data terminal to the fleet management system 325.

In some embodiments, the fleet management system 325 may have a fatigue determination element 327 that tracks the fatigue, use, wear, maintenance interval or maintenance requirements, or other states of elements of a vehicle. The fleet management system 325 may receive the flight parameter data or flight regime data from the data analysis element 305, and may provide the received data to the fatigue determination element 327. The fatigue determination element 327 may integrate any received flight parameter data or flight regime data into existing flight parameter data or flight regime data to determine current fatigue, use, wear, or other states of each monitored element of the aircraft as of the time of the windows associated with the flight parameter data or flight regime data. The fatigue determination element 327 may generate status data based on data related to the fatigue, use, wear, or other states of the monitored aircraft elements, and may provide the status data to a maintenance management system 329, usage management system 331, or the like, for handling of vehicle management tasks. In some embodiments, the maintenance management system 329 tracks maintenance of vehicle elements, and uses the status data to determine whether monitored elements of the vehicle need maintenance. The maintenance management system 329 may, when the maintenance management system 329 determines that maintenance is needed, generate maintenance appointments, adjust a schedule for an aircraft to include maintenance, provide a notice, alert or other indication to a maintenance manager or technician, or the like. The usage management system 331 may calculate acceptable usage for upcoming flight, missions, or the like. For example, the usage management system 331 may determine from the status data, the usage or fatigue available for future flights. The usage management system 331 may determine whether a particular aircraft has enough fatigue or usage available for a proposed mission.

The flight regime prediction system 301, data collection element 303, data analysis element 305, fleet management system 325, or individual elements or subsystems thereof may be implemented on one or more computer systems, for example, using standalone computers, one or more servers, and/or cloud computing resources or systems. Thus, the system 301 or a subsystem may have one or more processors and one or more non-transitory computer readable memory or media, which may store computer program code for implementing functionality of the system.

References to computer-readable storage medium, computer program product, tangibly embodied computer program, or the like, or a controller, display system, computer, processor, or the like should be understood to encompass not only computers having different architectures such as single or multi-processor architectures and sequential (Von Neumann) or parallel architectures but also specialized circuits such as field-programmable gate arrays (FPGAs), application specific circuits (ASICs), signal processing devices and other devices. References to computer program, instructions, code, or the like, should be understood to encompass software for a programmable processor or firmware such as, for example, the programmable content of a hardware device whether instructions for a processor, or configuration settings for a fixed-function device, gate array or programmable logic device, or the like.

The system may have at least one processor and at least one memory, such as a non-transitory computer readable medium, and may include computer program code, that is configured to, with the at least one processor, provide the LSTM model 315 features. The memory may be a single component or, may be implemented as one or more separate components, some or all of which may be integrated or removable and may provide permanent, semi-permanent, dynamic, or cached storage.

The one or more processors are configured to read from and write to at least one memory. The processor may also comprise an output interface via which data or commands are output by the processor and an input interface via which data or commands are input to the processor. The memory stores a computer program including computer program instructions that control the operation, when loaded into the processor, of the overall system 301, or one or more of the data collection element 303, data analysis element 305 or fleet management system 325. The computer program instructions provide the logic and routines that enable the apparatus to perform the LSTM model 315 training, regime determination, data analysis fatigue determination, or maintenance and usage management. The processor, by reading the memory, is able to load and execute the computer program. The computer program or programs may arrive at the apparatus via any suitable delivery mechanism. The delivery mechanism may be, for example, a computer-readable storage medium, a computer program product, a memory device, a record medium such as a compact disc read only memory (CD-ROM), digital versatile disc (DVD), portable memory such as a memory stick or hard drive, or the like, an article of manufacture that tangibly embodies the computer program. In some embodiments, the delivery mechanism may be a signal configured to reliably transfer the computer program over the air or via an electrical or optical connection.

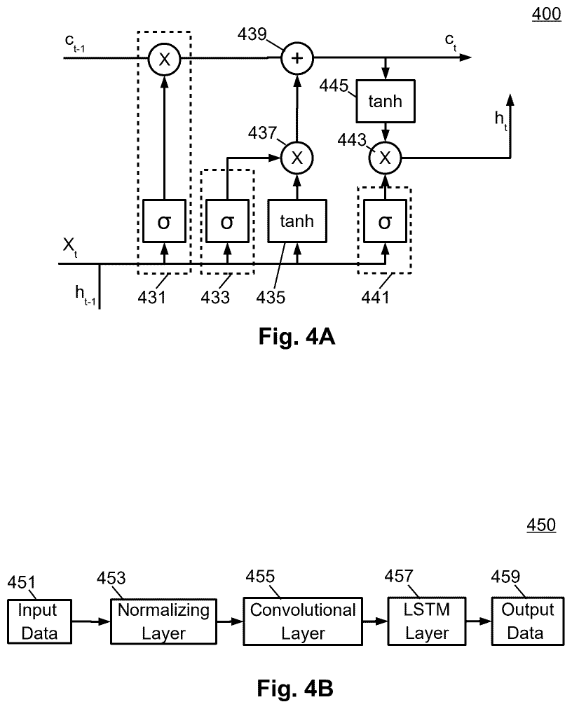

FIG. 4A is a logical diagram illustrating an LSTM neuron 400 according to some embodiments. An LSTM is a type of recurrent neural network designed to prevent the neural network output for a given input from either decaying or exploding as it cycles through the feedback loops. The feedback loops allow recurrent networks to be better at pattern recognition than other neural networks. Memory of past input is critical for solving sequence learning tasks and LSTMs provide better performance compared to other RNN architectures by alleviating what is called the vanishing gradient problem.

Due to their ability to learn long term dependencies, LSTMs are applicable to a number of sequence learning problems including language modeling and translation, acoustic modeling of speech, speech synthesis, speech recognition, audio and video data analysis, handwriting recognition and generation, sequence prediction, and protein secondary structure prediction. In particular, the handling of long-term dependencies is useful for analyzing the sequential data points associated with flight parameters. Additionally, LSTM architectures can be stacked to create deep architectures, enabling the learning of even more complex patterns and hierarchies in sequential data. Each LSTM layer in a stacked configuration captures different levels of abstraction and temporal dependencies within the input data.

The long short-term memory architecture consists of linear units with a self-connection having a constant weight of 1.0. This allows a value (forward pass) or gradient (backward pass) that flows into this self-recurrent unit to be preserved and subsequently retrieved at the required time step. With the unit multiplier, the output or error of the previous time step is the same as the output for the next time step. This self-recurrent unit, the memory cell, is capable of storing information which lies a dozen time-steps in the past. For example, for flight performance data, an LSTM neuron 400 can store information from the previous samples in a time window and apply this information to determine a pattern in the flight parameter samples and identify a flight regime from the pattern.

An LSTM neuron 400 maintains a cell state (cₜ) that represents the memory of the LSTM and can store information over long sequences. The data retained in the LSTM can be updated, cleared, or read from at each time step. A hidden state (hₜ) serves as an intermediary between the cell state and the external world. It can selectively remember or forget information from the cell state cₜ and produce the output.

The LSTM neuron 400 has a forget gate 431 that determines what information from the previous cell state cₜ₋₁ should be retained and what should be removed from the memory cell. The forget gate 431 allows the LSTM neuron 400 to forget or discard irrelevant information. The information that is no longer useful in the cell state is removed with the forget gate 431. Two inputs, the input at a particular time (Xₜ) and previous cell output (hₜ₋₁), are fed to the forget gate 431 and multiplied with weight matrices followed by the addition of bias. The resultant is passed through a sigmoid activation function (σ) which gives a binary output. If, for a particular cell state, the output is 0, the piece of information is forgotten and for output 1, the information is retained for future use. We multiply, using element-wise multiplication, the previous state cₜ₋₁ by the binary output to get, resulting in currently considered previous states disregarding the information we had previously chosen to ignore.

The LSTM neuron has an input gate 433 that controls the flow of information into the cell state cₜ, and can learn to accept or reject incoming data. The input gate 433 controls addition of useful information to the cell state. First, the information in inputs hₜ₋₁ and Xₜ is regulated using the sigmoid function (σ) and filtered to generate values to be remembered similar to the forget gate using inputs, the data input at a particular time (Xₜ) and previous cell output hₜ₋₁. Then, a vector is created by applying a tanh function 435 to inputs hₜ₋₁ and Xₜ to give an output from −1 to +1, which contains all the possible values from inputs hₜ₋₁ and Xₜ. At last, the values of the vector and the regulated values are multiplied, using an element-wise multiplication function 437, to obtain current useful information, which is added to the currently considered previous states to get a new current state cₜ representing the updated candidate values, adjusted for the amount by which each state value is updated.

An output gate 441 controls the information that is used to produce the output at each time step, and determines what part of the cell state should be revealed to the external world. The output gate 441 extracts useful information from the newly determined current cell state cₜ to be presented as output is done by the output gate 441. A vector is generated by applying a tanh function 445 to the current cell state cₜ. The inputs hₜ₋₁ and Xₜ are regulated using a sigmoid function and filtered to generate values to be remembered. The values of the vector and the regulated input values are multiplied using, for example, an element-wise multiplication function 443 to generate an output at time t (hₜ) that is used as an input to the next cell.

The ability to maintain state between processing runs by the LSTM permits the LSTM to effectively remember or store sequential data such as flight parameter data taken at different time within a sample window. As the LSTM receives a new group of flight parameters taken at a particular sampling time, the LSTM may include the newly acquire flight parameter data in the retained data, and may forget or discard the oldest retained set of flight parameter data to effectively select information along a time scale. In some embodiments, the LSTM uses forget gates to remove the old flight parameter data, or to exclude irrelevant data from storage in the LSTM.

FIG. 4B is a logical diagram illustrating a flight regime prediction system 450 with LSTM layers 457 according to some embodiments. The system 450 may take in input data 451 through an input or a normalizing layer 453. The normalizing layer 453 converts input data 451 into a format usable by subsequent layers, and scales input data 451 to a similar range. For example, the normalizing layer 453 may convert sensor data or flight parameter data into a numeric representation such as a matrix with the data values reflected in the matrix.

The normalizing layer 453 provides the prepared data to one or more convolutional layers 455 of, for example, a convolutional neural network (CNN). In a CNN, the convolutional layers 455 provide one or more convolutions or filters and may use filters that are trained by applying weights and biases to a variety of filters to identify desired or significant features from the input data 451. In some embodiments, the convolution layers 455 may provide probabilities or other data related to extracted or identified features. Convolution layers 455 may take advantage of hierarchical patterns in input data and assemble patterns of increasing complexity using smaller and simpler patterns in the filters of convolutional layers 455. Thus, convolution layers 455 utilize the hierarchical structure of the data they are processing. Convolution layers 455 break input data down into smaller, simpler features, which are represented by the filters of the convolutional layers. These filters are applied to different regions of the input to extract the relevant information. As the network progresses through the layers, these features are combined and assembled into more complex patterns, allowing the network to learn increasingly abstract representations of the input.

The LSTM layers 457 may identify whether an identifiable flight regime exists in a particular set of input data 451, with the convolutional layers 455 identifying potential patterns in the input data 451, and the LSTM layers 457 correlating the patterns with a flight regime. The LSTM layer may generate output data 459 associated with, identifying, or otherwise describing, the identified flight regime.

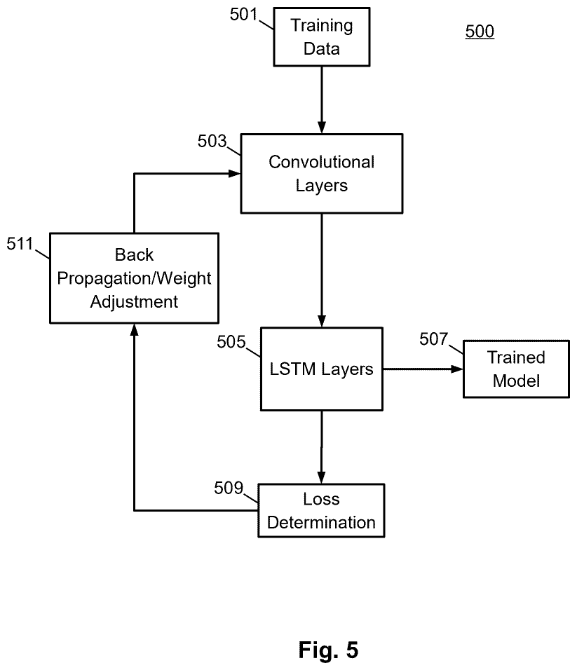

FIG. 5 is a flow diagram illustrating a system 500 for training of an LSTM system according to some embodiments. An AI model of using LSTM layers 505 stores state data for flight parameters as the flight parameters are input through the LSTM layers 505 so that the LSTM layers 505 are able to connect or correlate flight parameter data from different times in a sample window with flight parameter data for other times or parts of the sample window, and then to correlate sequences of data with flight regimes indicated by the flight parameter data. In some embodiments, training data 501 including one or more pieces of flight parameter data is provided or identified. The training data 501 provides data that can be used to train an AI model to identify, or avoid, certain types of data, and relate that data or series of data points to specified flight regimes. For example, when training a flight regime prediction AI agent, the training data 501 may be real, historical, or synthetic flight parameter data or sensor data, or the like, and may have data that can be positively identified as being associated with a particular flight regime. In another example, the flight parameter data that may be positively identified as not belonging to a particular flight regime. The potential flight regimes may each be a conceptual item that the AI agent should identify as being associated with a particular series of flight parameter data points.

The training data 501 may be preprocessed by an input layer (not shown) to prepare the training data 501 for filtering through one or more layers such as convolution layers 503. The convolution layers 503 may have filters with adjustable weights or biases that affect the weight given to the respective filter when processing the training data 501. The training data 501 may be processed through the convolution layers 503, and the resulting data is output to one or more LSTM layers 505.

The convolutional layers 503 may use, for example, a classifier to provide classification for each input data points from the training data 501. In some embodiments, the convolutional layers 503 may generate probabilities that each piece of input data belongs to a particular series of training data elements, or that a particular data point is relevant to flight regime prediction. In some embodiments, a Softmax function is applied to data output from the convolutional layers 503. Softmax is an activation function that scales numbers or unnormalized final scores (logits) into probabilities. In some embodiments, a threshold may be applied to the probabilities or other output generated by the convolutional layers 503 to determine the confidence level of classification or prediction.

During training of an AI agent, outputs from the LSTM layers 505 are passed to a loss determination element 509 that evaluates the results of the AI agent processing and provides data used to adjust weights and biases of the convolutional layers 503 by back propagation or weight adjustment 511.

The loss determination element 509 specifies how the model training is penalized by the deviation between the predicted output of the network, and the true or correct flight regime identification. Various loss functions can be used, depending on the specific task. In some embodiments, the loss determination element 509 applies a loss function that estimates the error of a set of weights in the convolutional layers 503. For example, errors in an output may be measured using cross-entropy. For example, in some training systems, the likelihood of any particular image belonging to a particular class is 1 or 0, as the class of the images is known. Cross entropy calculates the difference between an AI agent predicted probability distribution and true probability distribution given in the training data. The loss determination element 509 may use a cross-entropy analysis to determine loss for a particular set of training data 501.

Back propagation allows application of the total loss determined by the loss determination element 509 to be fed back into the neural network, and subsequent updating of the weights and correlations between data and flight regimes in a way that minimizes the loss by giving the nodes with higher error rates lower weights, and vice versa. For example, in some embodiments, a loss gradient may be calculated, and used, via back propagation or weight adjustment 511, for adjustment of the weights and biases in the convolution layers 503. In other embodiments, the loss determination layer 509 may be used to identify correlations inferred by the LSTM layers 505 between flight parameters and flight regimes, and to correct those correlations by, for example, adjusting the activation of associated slight parameters, series of flight parameters, input or output gate activation functions, forget gate activation functions, or the like. A gradient descent algorithm may be used to change the weights or flight parameter-to-flight regime correlations so that the next evaluation of a training data 501 set reduces the error identified by the loss determination element 509 and where the optimization algorithm navigates down the gradient (or slope) of error. Once the training data 501 is exhausted, or the loss of the model falls below a particular threshold, the AI agent may be saved, and used as a trained model 507.

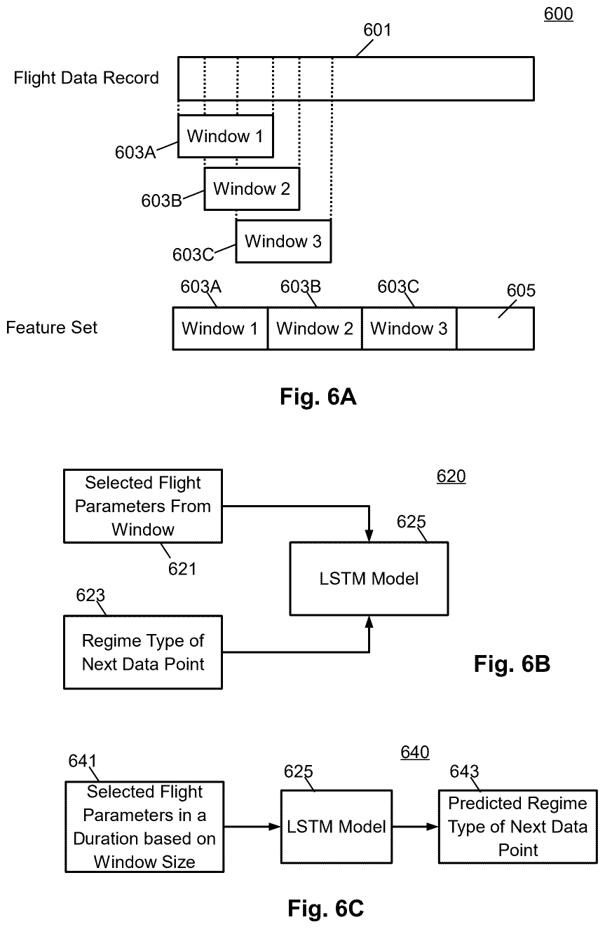

FIG. 6A is a logical diagram illustrating a system for selection of a training data feature set 605 for training an LSTM model according to some embodiments. On some embodiments, sensor data or flight parameters are disposed in a flight data record 601. The flight data record 601 may have data indicating a relationship between a time of collection for each flight parameter data point, and the collected flight parameter data point, and may represent the flight parameter data points sequentially according to time. This may align with the order in which the sensor data is collected.

A training data feature set 605 may include data from one or more sample windows 603A . . . 603C. Each sample window 603A . . . 603C may overlap in time in the flight data record 601, such that each sample window 603A . . . 603C may have one or more flight parameter data points that are the same as flight parameter data points in another sample window 603A . . . 603C. For example, a first sample window 603A may have one or more first flight parameter data points that are from a first time before a second sample window 603B starts, and may further have one or more second flight parameter data points that are from a second time within the second sample window 603B start and end times. Thus, the second flight parameter data points would be in both the first sample window 603A and second sample window 603B, while the first flight parameter data points would be in the first sample window 603A, but not in the second sample window 603B. Additionally, the data of the sample windows 603A . . . 603C may be arranged in the training data feature set.

FIG. 6B is a logical diagram illustrating a method 620 for using of training data to train an LSTM model according to some embodiments. In some embodiments, selected parameters from a sample window 621 may be provided to the LSTM model 625. In some embodiments, the training data is specific to a particular model of aircraft, or even to a specific aircraft, so that the flight regime is customized for accuracy. At least a portion of the training data, including the selected flight parameters may be generated by load level surveys flight tests where all potential maneuvers are flown with a load to determine flight regimes associated with the maneuvers and the particular load.

Additionally, data indicating a regime type for a next data point 623, or for the selected flight parameters from the sample window 621, is provided to the LSTM model. During training the LSTM model may associate the selected flight parameters from the sample window 621 with the provided regime type data for the next data point 623. The training of the LSTM model 625 causes the LSTM model 625 to form an association between the selected flight parameters from the sample window 621 and the flight regime type indicated by the regime type data for the next data point 623. Thus, the LSTM model 625 may use existing, or already collected data to determine what an upcoming flight regime will be. In some embodiments, a flight regime may be predicted for a future time, or prior to flight parameter data being collected or processed for that time.

FIG. 6C is a logical diagram illustrating a method for using an LSTM model 625 to predict flight regimes according to some embodiments. After the LSTM model is trained, the LSTM model may validate that the training makes the LSTM model 625 to return correct results for provided flight parameters. The LSTM model 625 may then be deployed to generate or predict flight regimes. In some embodiments, predicting fight regimes comprises providing selected flight parameters in a duration based on a window size 641 to the LSTM model 625. The duration of samples may have a duration set according to the training of the LSTM model 625, and may be a sliding window. Therefore, in some embodiments, as flight parameters or sensor readings are gathered, the selected flight parameters may be sent to the LSTM model, and the LSTM model 625 may shift the sample window to include the newly acquired flight parameter data and by forgetting data that is older than the sample window, or by leaving the older data out of processing for flight regime determination. In some embodiments, a sample window be offset from an immediately preceding sample window by one data point. Thus, each new sample window may have only one data point or data collection time that is different than an immediately preceding sample window. This permits complete coverage of all gathered sensor readings or flight parameters, with a granularity of a single set of flight parameters. Additionally, the LSTM model 625 may be able to accurately identify transitions or changes between flight regimes.

The LSTM model 625 generates a predicted regime type of a next data point 643. In some embodiments, the LSTM model 625 may determine whether a flight regime or regime type is indicated by data in the current sampling window, including the most recently received flight parameter data received in the selected flight parameters in a duration based on a window size 641. If the LSTM model 625 determines that a flight regime or regime type is indicated by the data in the sampling window, the LSTM model 625 determine the predicted regime or regime type is based on some, or all, of the data in the sampling window. The predicted regime type may then be reported or sent to, for example, a fleet management system, or used to generate an alert in a real-time system.

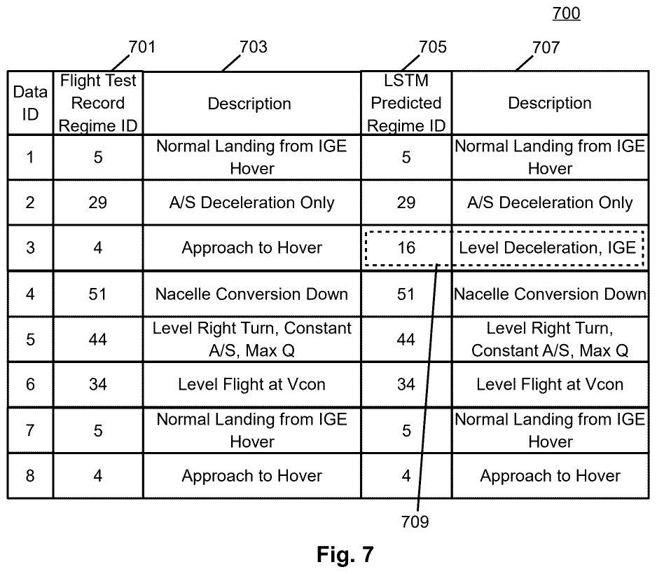

FIG. 7 is a table 700 illustrating LSTM regime prediction validation according to some embodiments. After training of an LSTM, the LSTM may be validated by providing test data, including known flight parameters associated with specific flight regimes. Validation data may include an actual flight regime ID 701 and, or readability, may include a description of the actual flight regime 703. Flight parameters for actual flight regimes may be provided to an LSTM, and the resulting predicted flight regime may be compared to the actual flight regime to ensure the LSTM properly predicts or identifies the correct flight regime for the given flight parameters. The predicted flight regime provided by an LSTM model may be included in the validation data, and may include a predicted flight regime ID 705 and precited flight regime description 797. In the provided example of the table, an incorrect result 709 is shown, where the predicted flight regime does not match the actual flight regime.

Performance of the LSTM model may be evaluated with test data to determine an accuracy level, the requirements for which may vary based on use cases. Identifying errors in the validation permits root cause analysis for the misidentification or false flight regime prediction, and potentially adjusting the configuration of the LSTM model, providing additional training, adding additional parameters for use in determining the flight regime, adjusting the convolutional layers to improve identification of significant features, or providing additional or different adjustments to the system to improve flight regime prediction accuracy.

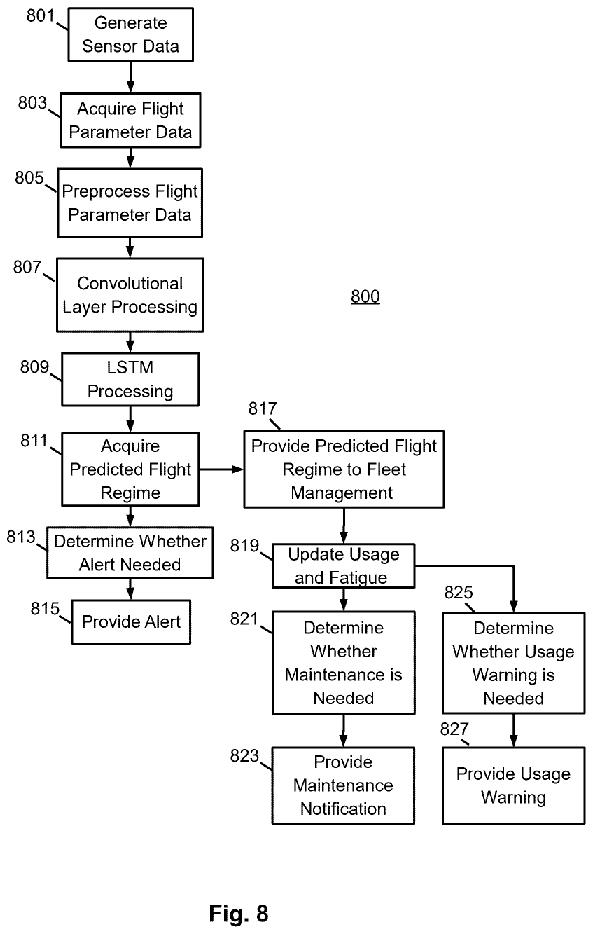

FIG. 8 is a flow diagram illustrating a method 800 for using an LSTM model for regime prediction according to some embodiments. In block 801, sensor data is generated. The sensor data may be generated by sensors within, for example, an aircraft or other vehicle. The sensors may monitor operation of the aircraft on a periodic basis. In block 803, flight parameter data is acquired. In some embodiments, the fight parameters may include flight parameters such as a calibrated airspeed, load factor, roll attitude, true heading, pitch rate, vertical velocity, rotor rpm, nacelle angle, thrust control lever position, radar altitude, LWINS ground speed, or the like. In other embodiments, the flight parameters for a rotorcraft may include calibrated airspeed, load factor, roll attitude, true heading, pitch rate, vertical velocity, rotor rpm, main rotor blade collective or cyclic angle, collective stick position, radar altitude, LWINS ground speed, or the like. In some embodiments, the flight parameters may be acquired directly from a system that determines the flight parameters directly, such as an FCC or ECCU, which may track particular flight parameters as part of the process of controlling the aircraft. In other embodiments, the flight parameters may be calculated from one or more sensor readings.

In block 805, the flight parameter data may be preprocessed to, for example, adjust or remove spurious data, to change the format or presentation of the data, or the like. The flight parameters are sent to one or more convolution layers for convolutional layer processing in block 807. The convolutional layers may process the flight parameter data to identify the data most relevant for flight regime determination, or may filter or otherwise process the flight parameter data. In block 809, LSTM processing performs the LSTM model may include the LSTM acquiring light parameter data that may be direct flight parameters, flight parameter data that is processed by the convolutional layers. Processing by the LSTM may include adjusting the sample window or flight parameters that are included in a sample window by including newly received flight parameters, and by discarding or forgetting one or more stored flight parameter data points or set, which in some embodiments, may include forgetting or excluding an oldest flight parameter data point of the previously stored flight parameter data. The LSTM may also include storing or remembering the received flight parameters or flight parameter data in the LSTM memory. The LSTM may be trained to associate one or more flight parameters, either from a single sample time, or across more than one sample time within the sample window, with a flight regime. The LSTM processing may further include predicting or identifying whether a flight regime is indicated by the flight parameters or flight parameter data, including the newly received flight parameter data and further according to previously received flight parameter data, and predicting or identifying the flight regime indicated by the fight parameter data. In block 811, the predicted flight regime is acquired. The predicted flight regime may be acquired as a result of LSTM processing, or data generated by the LSTM processing may be further processed to predict or determine the flight regime.

In block 813, a determination of whether an alert is needed is made. A monitoring system or the like may determine based, in some embodiments, on the most recently predicted or determined flight regime. The usage, wear or fatigue on one or more systems, subsystems or elements of the aircraft may be tracked, and may be adjusted based on the newly determined flight regime. In some embodiments, the alert system may determine that an alert should be raised when a tracked status of the aircraft elements exceeds a threshold, and in block 815 an alert may be raised. This permits real-time, or near real-time, determination or prediction of the flight regime to be used for real-time, or near real-time, alerts to, for example, a pilot. The real-time alert may be provided within about 500 milliseconds of the flight parameters being acquired. A near real-time alert may be provided within about 2 second of the flight parameters being acquired. This real-time or near-real-time alert permits efficient use of the determined or predicted flight regime without having to wait for processing results to determine wear, usage or fatigue during aircraft operation.

In block 817, the predicted or determined flight regime may be provided to a fleet management system. The fleet management system may update status or statistics for systems, subsystems or elements of an aircraft. In block 819, the fleet management system updates usage or fatigue status or statistics based on the predicted flight regime.

In block 821, a determination is made on whether maintenance is needed. In some embodiments, the fleet management system determines whether usage or fatigue status or statistics, after being updated according to the newly determined flight regime indicates that maintenance needs to be performed for a monitored aircraft element. In some embodiments, maintenance may be indicated when the fatigue or usage exceeds a threshold, and in some embodiments, may also be determined according to expected maintenance, previous maintenance, previous flight regime, or the like. In block 823, a maintenance notification is provided. In some embodiments, the fleet management system may provide a notification, alert or other indicator that maintenance on a monitored element is needed. In other embodiments, the fleet management system may automatically schedule maintenance, or add maintenance elements to an existing maintenance schedule.

In block 825, a determination is made in whether a usage warning is needed. In some embodiments, the fleet management system track usage of aircraft elements, and adjusts the usage, ear or fatigue based on determined or predicted flight regimes. The fleet management system may predict future usage or wear and determine whether a warning needs to be provided for a particular mission which may cause wear or usage to exceed an allowable limit or threshold. In block 827, a usage warning is provided, if needed. The usage warning may be a note in a fleet management system indicating that a particular aircraft may not be suitable for certain missions that would cause the wear, usage or fatigue on one or more monitored aircraft elements to exceed the allowable limit or threshold.

An embodiment system includes one or more processors, and at least one non-transitory computer readable memory connected to the one or more processors and including computer program code, where the at least one non-transitory computer readable memory and the computer program code are configured, with the one or more processors, to cause the system to at least provide a long short-term memory (LSTM) model trained to associate one or more flight parameters with a flight regime, where the flight regime is one or more actions taken during operation of an aircraft, acquire first flight parameter data associated with data collected at a sample time and during operation of an aircraft, provide the first flight parameter data to the LSTM model, the providing the first flight parameter data causing the LSTM model to predict a predicted flight regime according to the training of the LSTM and first flight parameter data, determine at least a fatigue statistic for one or more elements of the aircraft according to the predicted flight regime, and provide a notification regarding the fatigue statistic exceeding a threshold.

In some embodiments, providing the first flight parameter data further causes the LSTM to adjust a sample window to include the first flight parameter data and further causes the LSTM to generate stored flight parameter data that includes the first flight parameter data, and providing the first flight parameter data causes the LSTM model to predict the predicted flight regime according to the training of the LSTM and the stored flight parameter data. In some embodiments, providing the first flight parameter data further causes the LSTM to generate the stored flight parameter data to include the first flight parameter data and previously stored flight parameter data gathered at one or more times prior to the sample time and within the sample window. In some embodiments, providing the first flight parameter data further causes the LSTM to forget an oldest flight parameter data point of the previously stored flight parameter data. In some embodiments, the notification is provided in at least near real-time. In some embodiments, the one or more flight parameters includes one or more of a calibrated airspeed, load factor, roll attitude, true heading, pitch rate, vertical velocity, rotor rpm, radar altitude, or lightweight inertial navigation system (LWINS) ground speed. In some embodiments, the aircraft is one of a tilt-rotor aircraft or a rotorcraft.

An embodiment system includes one or more processors, and at least one non-transitory computer readable memory connected to the one or more processors and including computer program code, where the at least one non-transitory computer readable memory and the computer program code are configured, with the one or more processors, to cause the system to at least provide an artificial intelligence neural network with a long short-term memory (LSTM) model, where the at least one non-transitory computer readable memory and the computer program code are configured, with the one or more processors, to cause the LSTM model to at least maintain one or more associations between one or more flight parameters and one or more flight regimes, where each flight regime of the one or more flight regimes is one or more actions taken during operation of an aircraft, maintain first stored flight parameter data having collection times within a sample window, receive first received flight parameter data associated with data collected at a sample time and during operation of an aircraft, adjust the sample window to include the first received flight parameter data and to generate second stored flight parameter data that includes the first received flight parameter data, and predict a predicted flight regime according to the one or more associations and the stored second flight parameter data, and provide data indicating the predicted flight regime to a system that generates a notification based on the predicted flight regime.

In some embodiments, providing the data to the system that generate the notification causes the system to generate an alert to a pilot according to at least one of a fatigue statistic or a usage statistic associated with the predicted flight regime and for one or more elements of the aircraft exceeding a threshold. In some embodiments, providing the data to the system that generates the notification includes causing the system to generate, for one or more elements of the aircraft, a maintenance notification according to at least one of a fatigue statistic or a usage statistic associated with the predicted flight regime exceeding a threshold. In some embodiments, generating the second stored flight parameter data includes generating the second stored flight parameter data to include the first received flight parameter data and previously stored flight parameter data gathered at one or more time prior to the sample time and within the sample window. In some embodiments, generating the second stored flight parameter data includes generating the second stored flight parameter data to include the first received flight parameter data and the previously stored flight parameter data, excluding an oldest flight parameter data point of the previously stored flight parameter data. In some embodiments, the one or more flight parameters includes one or more of a calibrated airspeed, load factor, roll attitude, true heading, pitch rate, vertical velocity, rotor rpm, radar altitude, or lightweight inertial navigation system (LWINS) ground speed. In some embodiments, the artificial intelligence neural network further includes one or more convolution layers, where the at least one non-transitory computer readable memory and the computer program code are configured, with the one or more processors, to cause the one or more convolutional layers to at least receive the first received flight parameter data, process the first received flight parameter data to identify the data most relevant for flight regime determination, and provide the processed first received flight parameter data to the LSTM.

An embodiment method includes providing a long short-term memory (LSTM) model trained to associate one or more flight parameters with a flight regime, where the flight regime is one or more actions taken during operation of an aircraft, acquiring first flight parameter data associated with data collected at a sample time and during operation of an aircraft, providing the first flight parameter data to the LSTM model, the providing the first flight parameter data causing the LSTM model to predict a predicted flight regime according to the training of the LSTM and first flight parameter data, determining at least a fatigue statistic for one or more elements of the aircraft according to the predicted flight regime, and providing a notification regarding the fatigue statistic exceeding a threshold.

In some embodiments, providing the first flight parameter data further causes the LSTM to adjust a sample window to include the first flight parameter data and further causes the LSTM to generate stored flight parameter data that includes the first flight parameter data, and providing the first flight parameter data causes the LSTM model to predict the predicted flight regime according to the training of the LSTM and the stored flight parameter data. In some embodiments, providing the first flight parameter data causes the LSTM to generate the stored flight parameter data to include the first flight parameter data and previously stored flight parameter data gathered at one or more time prior to the sample time and within the sample window. In some embodiments, providing the first flight parameter data further causes the LSTM to forget an oldest flight parameter data point of the previously stored flight parameter data. In some embodiments, the notification is provided in at least near real-time. In some embodiments, the one or more flight parameters includes one or more of a calibrated airspeed, load factor, roll attitude, true heading, pitch rate, vertical velocity, rotor rpm, radar altitude, or lightweight inertial navigation system (LWINS) ground speed.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system, comprising:
one or more processors; and
at least one non-transitory computer readable memory connected to the one or more processors and including computer program code, wherein the at least one non-transitory computer readable memory and the computer program code are configured, with the one or more processors, to cause the system to at least:
provide a long short-term memory (LSTM) model trained to associate one or more flight parameters with a flight regime, wherein the flight regime is one or more actions taken during operation of an aircraft;
acquire first flight parameter data associated with data collected at a sample time and during operation of an aircraft;
provide the first flight parameter data to the LSTM model, the providing the first flight parameter data causing the LSTM model to predict a predicted flight regime according to the training of the LSTM and first flight parameter data;
determine at least a fatigue statistic for one or more elements of the aircraft according to the predicted flight regime; and
provide a notification regarding the fatigue statistic exceeding a threshold.

2. The system of claim 1, wherein the providing the first flight parameter data further causes the LSTM to adjust a sample window to include the first flight parameter data and further causes the LSTM to generate stored flight parameter data that includes the first flight parameter data; and
wherein the providing the first flight parameter data causes the LSTM model to predict the predicted flight regime according to the training of the LSTM and the stored flight parameter data.

3. The system of claim 2, wherein the providing the first flight parameter data further causes the LSTM to generate the stored flight parameter data to include the first flight parameter data and previously stored flight parameter data gathered at one or more times prior to the sample time and within the sample window.

4. The system of claim 3, wherein the providing the first flight parameter data further causes the LSTM to forget an oldest flight parameter data point of the previously stored flight parameter data.

5. The system of claim 1, wherein the notification is provided in at least near real-time.

6. The system of claim 1, wherein the one or more flight parameters comprises one or more of a calibrated airspeed, load factor, roll attitude, true heading, pitch rate, vertical velocity, rotor rpm, radar altitude, or lightweight inertial navigation system (LWINS) ground speed.

7. The system of claim 6, wherein the aircraft is one of a tilt-rotor aircraft or a rotorcraft.

8. A system, comprising:
one or more processors; and
at least one non-transitory computer readable memory connected to the one or more processors and including computer program code, wherein the at least one non-transitory computer readable memory and the computer program code are configured, with the one or more processors, to cause the system to at least:
provide an artificial intelligence neural network with a long short-term memory (LSTM) model, wherein the at least one non-transitory computer readable memory and the computer program code are configured, with the one or more processors, to cause the LSTM model to at least:
maintain one or more associations between one or more flight parameters and one or more flight regimes, wherein each flight regime of the one or more flight regimes is one or more actions taken during operation of an aircraft;
maintain first stored flight parameter data having collection times within a sample window;
receive first received flight parameter data associated with data collected at a sample time and during operation of an aircraft;
adjust the sample window to include the first received flight parameter data and to generate second stored flight parameter data that includes the first received flight parameter data; and
predict a predicted flight regime according to the one or more associations and the stored second flight parameter data; and
provide data indicating the predicted flight regime to a system that generates a notification based on the predicted flight regime.

9. The system of claim 8, wherein providing the data to the system that generates the notification causes the system to generate an alert to a pilot according to at least one of a fatigue statistic or a usage statistic associated with the predicted flight regime and for one or more elements of the aircraft exceeding a threshold.

10. The system of claim 8, wherein providing the data to the system that generates the notification comprises causing the system to generate, for one or more elements of the aircraft, a maintenance notification according to at least one of a fatigue statistic or a usage statistic associated with the predicted flight regime exceeding a threshold.

11. The system of claim 8, wherein the generating the second stored flight parameter data comprises generating the second stored flight parameter data to include the first received flight parameter data and previously stored flight parameter data gathered at one or more time prior to the sample time and within the sample window.

12. The system of claim 11, wherein the generating the second stored flight parameter data comprises generating the second stored flight parameter data to include the first received flight parameter data and the previously stored flight parameter data, excluding an oldest flight parameter data point of the previously stored flight parameter data.

13. The system of claim 8, wherein the one or more flight parameters comprises one or more of a calibrated airspeed, load factor, roll attitude, true heading, pitch rate, vertical velocity, rotor rpm, radar altitude, or lightweight inertial navigation system (LWINS) ground speed.

14. The system of claim 8, wherein the artificial intelligence neural network further comprises one or more convolution layers, wherein the at least one non-transitory computer readable memory and the computer program code are configured, with the one or more processors, to cause the one or more convolutional layers to at least:
receive the first received flight parameter data;
process the first received flight parameter data to identify the data most relevant for flight regime determination; and
provide the processed first received flight parameter data to the LSTM.

15. A method, comprising:
providing a long short-term memory (LSTM) model trained to associate one or more flight parameters with a flight regime, wherein the flight regime is one or more actions taken during operation of an aircraft;
acquiring first flight parameter data associated with data collected at a sample time and during operation of an aircraft;
providing the first flight parameter data to the LSTM model, the providing the first flight parameter data causing the LSTM model to predict a predicted flight regime according to the training of the LSTM and first flight parameter data;
determining at least a fatigue statistic for one or more elements of the aircraft according to the predicted flight regime; and
providing a notification regarding the fatigue statistic exceeding a threshold.

16. The method of claim 15, wherein the providing the first flight parameter data further causes the LSTM to adjust a sample window to include the first flight parameter data and further causes the LSTM to generate stored flight parameter data that includes the first flight parameter data; and
wherein the providing the first flight parameter data causes the LSTM model to predict the predicted flight regime according to the training of the LSTM and the stored flight parameter data.

17. The method of claim 16, wherein the providing the first flight parameter data causes the LSTM to generate the stored flight parameter data to include the first flight parameter data and previously stored flight parameter data gathered at one or more time prior to the sample time and within the sample window.

18. The method of claim 17, wherein the providing the first flight parameter data further causes the LSTM to forget an oldest flight parameter data point of the previously stored flight parameter data.

19. The method of claim 15, wherein the notification is provided in at least near real-time.

20. The method of claim 15, wherein the one or more flight parameters comprises one or more of a calibrated airspeed, load factor, roll attitude, true heading, pitch rate, vertical velocity, rotor rpm, radar altitude, or lightweight inertial navigation system (LWINS) ground speed.
